(19) United States
(12) Patent Application Publication
(10) Pub. No.: US 2026/0287466 A1
(43) Pub. Date: Sep. 24, 2026

(54) MICROSCOPE SPECTROMETER FOR NON-DESTRUCTIVE TESTING OF PHOTONIC INTEGRATED CIRCUITS

(71) Applicant: PHOTONIC INC., Coquitlam (CA)

(72) Inventors: Mohsen KESHAVARZ AKHLAGHI, North Vancouver (CA); Gary WOLFOWICZ, Vancouver (CA)

(21) Appl. No.: 19/471,688

(22) PCT Filed: Mar. 28, 2024
(86) PCT No.: PCT/CA2024/050409

§ 371 Date: Oct. 1, 2025

Related U.S. Application Data
(60) Provisional application No. 63/494,730, filed on Apr. 6, 2023.

(51) Int. Cl. G01M 11/00

(52) U.S. Cl. CPC G01M 11/35

(57) ABSTRACT

A system for testing photonic devices includes a magnifying imaging system, and an optical system arranged to deliver a test light beam from a test light source to an optical port of the photonic device. The optical system is arranged to collect reflected and/or transmitted response light emitted at one or more locations on the photonic circuit. The response light is detected at one or more detectors. The test light source may include a narrow bandwidth variable wavelength laser. The system may be applied to accurately measure functionality, for example resonant wavelengths, of elements of the photonic device.

### CROSS-REFERENCE TO RELATED APPLICATION

This application claims priority from U.S. application No. 63/494,730 filed 6 Apr. 2023 and entitled MICROSCOPE SPECTROMETER FOR NON-DESTRUCTIVE TESTING OF PHOTONIC INTEGRATED CIRCUITS which is hereby incorporated herein by reference for all purposes. For purposes of the United States of America, this application claims the benefit under 35 U.S.C. § 119 of U.S. application No. 63/494,730 filed 6 Apr. 2023 and entitled MICROSCOPE SPECTROMETER FOR NON-DESTRUCTIVE TESTING OF PHOTONIC INTEGRATED CIRCUITS which is hereby incorporated herein by reference for all purposes.

### FIELD

This invention relates to apparatuses, systems and methods for testing photonic devices. Example embodiments are operable to measure performance of elements of photonic devices as a function of optical wavelength.

### BACKGROUND

Integrated photonic devices have many applications and are becoming increasingly important. An integrated photonic device may include optical components (e.g. waveguides, resonators, optical switches, optical filters, beamsplitters and so on) that are fabricated on a substrate (e.g. a silicon substrate). It is a problem that the performance of an optical component can vary significantly as a result of very small (e.g. nanometer scale) variations in dimensions and/or material properties. Consequently, the performance of optical components in an integrated photonic device may vary significantly as a result of variations in a fabrication process used to produce the integrated photonic device. For example, a particular fabrication process for producing a photonic device may begin by creating a sheet of a silicon-on-insulator wafer that provides a device layer having a thickness of 220 nm±10 nm. Even if all further steps for producing the integrated photonic device could be executed perfectly (zero deviation from design values), the uncertainty in device layer thickness may cause uncertainties of more than 10 nm in resonance wavelengths of micro-cavities formed in the device layer. This would be a problem in an applications which require the optical cavities to have resonant wavelengths that are tightly specified (e.g. to within ±0.1 nm for alignment of resonances to a set target).

The above problems are particularly acute at the prototype stage where prototypes of a photonic device are being made. At the prototyping stage the fabrication process is not yet proven and it is generally not practical to optimize and stabilize the fabrication process for making a few prototypes of a device as can be done for large scale production of identical photonic devices.

An integrated photonic device may be tested to determine whether its structure, as fabricated, matches the structure, as designed. For example, dimensions and material properties of the integrated photonic device may be measured using instruments such as:
optical microscopes,
scanning electron microscopes (SEM), which are often equipped with various sensors and characterization method such as secondary and backscattered electron imaging, X-ray analysis, electron channeling, etc., and
thin-film characterization instruments (e.g. profilometers, interferometers, ellipsometers, etc.).

Measurements made by any one of these instruments only provide limited insight regarding performance of the photonic device because the photonic functionality of the integrated photonic device is generally a complicated function of a large number of dimensions and material properties. For example, the resonance wavelength and quality factor of a photonic cavity is a function of factors which include dimensions of the photonic cavity, optical indices of the materials that make up the cavity, roughness of walls of the cavity, the presence of any contaminants close to the cavity, fabrication defects in or near the cavity (e.g. voids), and other factors.

It is generally difficult to assess how deviations from design will affect performance of the integrated photonic device individually or in the aggregate. Obtaining enough measurements to evaluate an integrated device using available instruments of the types discussed above can be difficult and time-consuming. Additionally, some of measurement tools are destructive. For example, an integrated photonic device must be cut apart to obtain focused ion beam SEM cross sections of the device.

Even if measurements are obtained, quantitatively connecting the result of the various measurements to predict performance of the photonic device is often not possible without building and running computer simulations, which can be time consuming. For example, an ellipsometer may be able to measure that an index of refraction of a material in a photonic device has a value that deviates by 1% from a design value. However, it can be difficult or impossible to assess the importance of this deviation in the index of refraction to the function of the material in the photonic device without computation.

Furthermore, photonic devices can be ultra-sensitive to small changes in dimensions and/or material properties. To characterize the dimensions and material properties of a photonic device sufficiently to assess the performance of the photonic device by simulation can require very high precision measurements which, in turn, require expensive measuring equipment used with care and skill. Apparatus capable of measuring some factors that can affect performance of a photonic device may be hard to obtain or unavailable. For example, the presence of a one Angstrom thick layer of contaminant on a surface of a photonic cavity may cause a large reduction in quality factor while detecting a one Angstrom thick layer of material may be very challenging even with the best available equipment.

All of the above issues are more pronounced when the photonic device must satisfy high performance specifications. For example, to make silicon photonic waveguides that have a loss of less than 1 dB/cm may require making surfaces of the waveguide have a root-mean-square of roughness that is much less than 1 nm. As another example, to make photonic cavities in silicon that have resonant wavelengths that match to within ±1 nm may require controlling dimensions to tolerances that are much smaller than 1 nm. Verifying such sub-nanometer requirements by measurement is beyond the resolution of many microscopy tools of the type that are conventionally used to verify dimensions of as-fabricated structures in silicon.

There is a need for, apparatuses and systems that are operable to efficiently and non-destructively test photonic devices. There is a particular need for such apparatus and methods that are constructed to allow efficient testing of small numbers (e.g. one or a few) photonic devices (e.g. in testing prototype photonic devices).

### SUMMARY

The present technology has a number of aspects which include without limitation: methods for testing photonic devices, systems for testing photonic devices, and workflows for prototyping and fabricating photonic devices.

One aspect of the invention provides system for testing a device under test (DUT) that is moveable relative to an objective lens. The system comprises a first optical system that comprises a viewer configured to observe the DUT when illuminated by an illumination light, emitted by a light source, through the objective lens. A second optical system comprises a optical elements configured to deliver a test light beam, emitted from a test light source, to be incident onto the DUT through the objective lens. The test light beam is transmitted or reflected as transmitted and/or reflected response light upon being incident on the DUT. One or more detectors is configured to detect the transmitted and/or reflected response light from the DUT. The first optical system may comprise the light source. The second optical system may comprise the test light source.

The DUT may be supported by a stage operable to move the DUT relative to the objective lens. The system may comprise the stage.

In some embodiments the stage is operable to position the DUT in two or more degrees of freedom by translation and/or rotation. In some embodiments the stage is operable to position the DUT in 6 degrees of freedom.

In some embodiments the system comprises a controller configurable to control the optical elements and/or the stage to vary an angle of incidence of the test light beam on the DUT. The angle of incidence of the test light beam on the DUT may be selected to couple light from the test beam into an optical element internal to the DUT.

In some embodiments the system comprises a marker light source configurable to emit first and second marker beams wherein the first marker beam is aligned with the reflected response light along a first optical path and the second marker beam is aligned with the transmitted response light along a second optical path.

In some embodiments the controller is configurable to deliver the test light beam to a desired location on the DUT by operating the stage and/or adjusting the optical elements so that a spot of light made by the first marker beam on the DUT is positioned at the desired location. The desired location may, for example, be at any one of the plurality of optical ports on the DUT.

In some embodiments the controller is configurable to control the optical elements to deliver the second marker beam to a location on the DUT from which the transmitted response light is expected to be emitted. The location on the DUT from which the transmitted response light is expected to be emitted may be at one of the plurality of optical ports on the DUT.

In some embodiments one of the plurality of optical ports from which the transmitted response light is emitted is different from the one of the plurality of optical ports to which the test light beam is incident.

In some embodiments the first and second optical paths are configurable to collect response light from first and second optical ports of a plurality of optical ports that are spaced apart from one another on the DUT.

In some embodiments each of the plurality of optical ports comprises a grating coupler.

In some embodiments the optical elements comprises a wavelength selective reflector in the first optical path configured to direct reflected illumination light and reflected first and second marker beams to the viewer and allow reflected and/or transmitted response light to proceed to respective detectors of the one or more detector.

In some embodiments the optical elements comprises a first light steering unit in the first optical path configured to steer the test light beam and/or the first marker beam to the desired location on the DUT through the objective lens.

In some embodiments the detectors comprises a reflected response light detector and the optical elements comprises a first directional coupler in the first optical path configured to direct the reflected response light to the reflected response light detector.

In some embodiments the first directional coupler comprises a light circulator and a polarization control unit wherein the polarization control unit is configured to apply polarization to the reflected response light such that the light circulator directs the reflected response light to the reflected response light detector.

In some embodiments the optical elements comprises a first beam combiner in the first optical path configured to combine the test light beam and the first marker beam before the test light beam and/or the first marker beam is steered by the first light steering unit.

In some embodiments the optical elements comprises a second light steering unit in the second optical path configured to steer the second marker beam to the location on the DUT from which the transmitted response light is expected to be emitted.

In some embodiments the detectors comprise a transmitted response light detector and the optical elements comprises a second directional coupler in the second optical path configured to direct the transmitted response light to the transmitted response light detector.

In some embodiments the second optical system comprises the test light source. In some embodiments the test light source comprises a tunable laser and the system is configured to sweep a wavelength of light emitted by the tunable laser over a wavelength range while detecting the transmitted and/or reflected response light from the DUT. In some embodiments the tunable laser has a linewidth of 100 MHz or less. In some embodiments the tunable laser has a wavelength in the range of 400 nm to 1600 nm.

In some embodiments the marker light source comprises a laser and the laser is configured to emit first and second marker beams with a wavelength outside of the wavelength range of the test light beam. In some embodiments the first and second marker beams have a wavelength in the visible light spectrum. In some embodiments the wavelength range of the test light beam is outside the visible light spectrum.

In some embodiments the system is configured to sweep a wavelength of the test light beam through a wavelength range from about 1300 nm to about 1350 nm. In some embodiments the first and second marker beams have a wavelength of about 980 nm.

In some embodiments the system comprises a data acquisition unit configured to receive output signals from the one or more detectors.

In some embodiments the system comprises an analysis unit configured to store and/or analyze data e.g. from the data acquisition unit. In some embodiments the analysis unit is configured to determine a resonant wavelength and/or a quality factor for one or more optical structures of the DUT.

Another aspect of the invention provides a method for testing photonic devices. The method comprises: (i) directing a first marker beam from a marker light source through a first optical path to a first optical port of a device under test (“DUT”); (ii) directing a second marker beam from the marker light source through a second optical path to a second optical port on the DUT; and (iii) while directing a test light beam from a test light source through the first optical path onto the DUT, collecting reflected response light by way of the first optical path and/or collecting transmitted response light by way of the second optical path.

In some embodiments the method comprises adjusting the first marker beam to be incident on the first optical port at a desired angle of incidence.

In some embodiments the method comprises the step of de-activating the marker light source before step (iii).

In some embodiments the method comprises the step of viewing a magnified image of the DUT under an illumination light through a viewer.

In some embodiments the method comprises the step of measuring the reflected response light by a reflected response light detector and measuring the transmitted response light by a transmitted response light detector.

Another aspect of the invention provides apparatus having any new and inventive feature, combination of features, or sub-combination of features as described herein.

Another aspect of the invention provides methods having any new and inventive steps, acts, combination of steps and/or acts or sub-combination of steps and/or acts as described herein.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1 is a schematic diagram of a system for testing photonic devices according to an example embodiment.

FIG. 2 is a partial top view of an example photonic device.

FIG. 2A is a plot showing a reflected response signal as a function of test light wavelength.

FIG. 3 is a schematic diagram of an optical arrangement of a system for testing photonic devices according to another example embodiment.

FIG. 4 is a schematic diagram of another optical arrangement for a system for testing photonic devices according to another example embodiment.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

The present technology provides apparatus for testing photonic devices and related methods. The testing systems and methods may be used to obtain information that directly characterizes an end photonic function of a photonic device. For example the testing systems and methods may be used to measure a resonant wavelength and/or quality factor of a photonic device.

In some embodiments the testing apparatus comprises a microscope, a test light source operable to emit a beam of test light, means for adjusting the beam of test light emitted by the test light source to be incident on a first optical port of a photonic device, a light detector, and means for collecting response light emitted from the first optical port or a second optical port of the device under test and directing the collected light to the light detector.

In some embodiments testing apparatus is configurable to sweep a wavelength of test light emitted by the test light source over a desired range. In such embodiments the test light source may, for example, comprise a narrowband tunable laser light source.

In some embodiments an angle of incidence of the test light beam onto the first optical port is adjustable.

In some embodiments the test apparatus is manually controlled. In some embodiments some control functions of the test apparatus are automated.

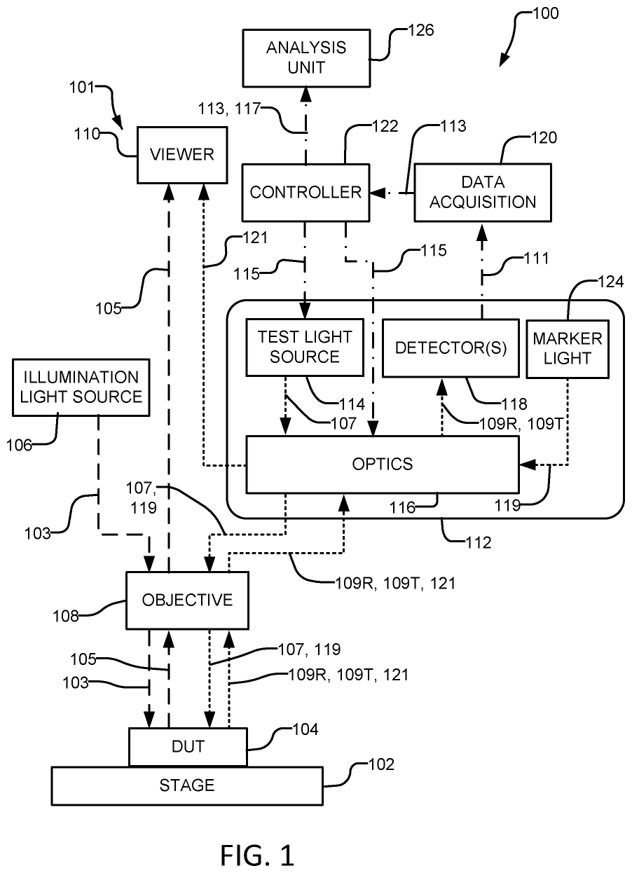

FIG. 1 schematically illustrates an example testing system 100 that is operable to test photonic devices. System 100 comprises a stage 102. A device under test (“DUT”) 104 may be mounted to stage 102 for testing by system 100. Stage 102 may comprise any suitable stage that is operable to position DUT 104. For example, stage 102 may be operable to translate and/or rotate a DUT 104 to achieve a desired positioning of DUT 104 relative to components of test system 100.

For example, stage 102 may comprise a 3-axis stage operable to translate a DUT 104 along mutually perpendicular x, y and z directions. In some embodiments, stage 102 is operable to position DUT 104 in 6 degrees of freedom. For example, stage 102 may comprise an XYZRT stage that is controllably operable to translate DUT 104 in each of x, y, and z directions as well as to rotate DUT 104 about a rotation axis as well as to tilt DUT 104 about each of two tilt axes.

Stage 102 may be operated manually and/or under control of a controller 122 of test system 100. DUT 104 may comprise any suitable photonic device for testing.

System 100 comprises a microscope 101 that is operable to view magnified images of a DUT 104. A user may use microscope 101 to observe the surface of a DUT 104. The user may, for example, use microscope 101 to locate optical ports provided on the DUT 104.

In the illustrated embodiment, microscope 101 comprises an objective lens 108 and a viewer 110. A light source 106 is operable to illuminate a surface of DUT 104 with illumination light 103. Illumination light 103 may, for example, be white light or light having a selected monochrome or other chromaticity. In the illustrated embodiment, illumination light 103 is directed onto DUT 104 through objective lens 108. A portion of illumination light 103 is reflected from DUT 104 as reflected illumination light 105. Reflected illumination light 105 is collected by objective lens 108 and directed to viewer 110. Viewer 110 may comprise any suitable optical devices and/or displays which facilitate user observation of an image of DUT 104. In some embodiments, viewer optics 110 comprises a camera and, optionally, a display connected to display images acquired by the camera. In some embodiments, viewer 110 comprises a monocular or binocular eyepiece.

System 100 additionally comprises an optical system 112 operable to emit one or more beams of test light and to collect, from a DUT 104, response light 109 resulting from interaction of the test light with a DUT 104.

In example system 100, optical system 112 comprises a test light source 114 configured to emit a beam of test light 107 (illustrated as dotted arrow in FIG. 1) into optics 116 of optical system 112. Optics 116 direct test light beam 107 onto DUT 104 by way of objective lens 108. Light from test light beam 107 is received at an optical port of DUT 104 and interacts with DUT 104 to yield response light 109. Response light 109 may be “reflected” (i.e. emitted from the same optical port into which test light beam 107 is directed) or “transmitted” (i.e. emitted at an optical port of the DUT that is different from the optical port into which test light beam 107 is directed). In some embodiments, system 100 is configured to collect both reflected response light 109R and transmitted response light 109T. Reflected response light 109R may be collected at the same location at which test light beam 107 is incident on DUT 104. Transmitted response light 109T may be collected at another location on DUT 104 that is selected by a user.

Response light 109R and 109T is directed to light detector(s) 118 by way of objective lens 108 and optics 116.

In some embodiments system 100 includes a marker light source 124 that is operable to emit a marker beam 119 of visible light. For example, marker light source 124 may comprise a laser diode that emits visible light. Optics 116 are configured to direct marker beam 119 to be incident on DUT 104 at the same location that test light beam 107 is incident on DUT 104. Marker beam 119 is reflected from DUT 104 as reflected marker beam 121. Reflected marker beam 121 is directed by objective lens 108 and optics 116 to viewer 110 to allow a user to view a spot of light made by marker beam 119 on DUT 104. Marker beam 119 may be turned on to mark a spot at which test light beam 107 will be incident on DUT 104.

System 100 may be configured so that light from marker light 124 does not adversely affect measurements made using system 100. For example:
In some embodiments optics 116 include an element (e.g. a movable mirror) that is positionable to selectively allow either test light beam 107 or marker beam 119 to be incident on a DUT 104.
In some embodiments controller 122 is configured to turn marker light 124 off while test light source 114 is turned on.
In some embodiments the spectrum of light emitted by marker light 124 is selected to not interfere with measurements being made by system 100.
In some embodiments optics 116 includes one or more filters that attenuate light emitted by marker light 124 in light paths leading to detector(s) 118 to levels such that measurements made by detector(s) 118 are not affected by presence of light from marker light 124.

A user and/or controller 122 may control optics 116 to deliver test light beam to a desired location by viewing a spot of light made by marker beam 119 on DUT 104 and moving DUT by stage 102 so that the spot of light is positioned at a location where it is desired that test light beam 107 will be incident on DUT 104.

In some embodiments test light source 114 is configured to sweep over a range of wavelength (i.e. vary test light beam 107 over a wavelength range). The wavelength range may include wavelengths at which DUT 104 is designed to be operated. In some embodiments the wavelength of light in test light beam 107 is varied over a wavelength range outside the visible light spectrum (e.g. in the infrared spectrum) and not visible to a user through viewer 110 while the marker beam 119 is of a wavelength that is within the visible light spectrum (e.g. green light or red light) and visible to the user through viewer 110. In some embodiments marker beam 119 comprises narrowband visible light and illumination light 103 comprises broadband light. In some embodiments test light beam 107 and marker beam 109 have spectra that allow light from test light beam 107 and marker beam 109 to be separated by wavelength selective filters.

In some embodiments test light source 114 comprises a tunable laser (e.g. laser 414). In some embodiments test light beam 107 has a wavelength in the range of about 1310 nm.

For various measurements the wavelength of test light beam 107 may be swept over a range. The swept range of wavelengths may be controllable to allow a user to customize the swept range of wavelengths to a particular measurement. For example, the swept range may correspond to a particular telecommunication band (e.g. O band at 1260 nm to 1360 nm or C band at 1530 nm to 1565 nm). In some cases the swept range may be set based on the nature of a device being tested. For example, a device may be expected to exhibit a resonance within a particular wavelength range. A user may initially set the swept range to include the range of wavelengths within which the resonance is expected. A different swept range may be selected if the resonance is not found. Another factor that may be used to select the swept range is the frequency response of optical port(s) of a DUT that are being used for a test. The swept range may be selected to be within a wavelength range that is passed by the optical port(s) in question.

A wavelength sweep rate of test light source, 114 may be fast enough for essentially real-time measurements (e.g. a sweep over a range of 100 nm may be completed in 5 seconds or less). For example, in some embodiments the wavelength sweep rate of test light source 114 is at least 20 nm/second or at least 50 nm/second or is in the range of 20 to 100 nm/second.

Test light source 114 has sufficient power that response light (109R and/or 109T as applicable) is measurable with a desired resolution by detector(s) (118, 318A, 318B, 418A, 418B, as applicable). The required power level depends at least in part on the characteristics of the detectors and associated data acquisition system as well as on optical characteristics of the DUT such as the degree to which response light 109R, 109T, as applicable, is expected to be attenuated by the DUT relative to test light beam 107 as well as performance of the optical paths provided by system 100, 300, 400). Advantageously, test light beam 107 may have a relatively low intensity such that optical components of a DUT are not damaged by the light from test light beam 107.

In some embodiments, the light emitted by test light source 114 has a sharp line width (e.g. a line width of 12 GHz or 10 GHz or 6 GHz or 100 MHz or less or a line width of λ×5×10⁻⁶ or less where λ is the wavelength). A narrow linewidth permits sharp features of the spectral response of a DUT to be detected and measured accurately.

Test light source 114 is preferably stable in intensity and wavelength. This facilitates resolution of spectral features of a DUT.

Test light beam 107 may be continuous, pulsed or selectively continuous or pulsed.

In some embodiments, test light beam 107 is made up of polarized light. The polarization of test light beam 107 may be controlled to match a polarization desired for testing a particular DUT. For example, the light of test beam 107 may be linearly polarized. The direction of polarization may be adjustable to align with a preferred direction for testing a DUT. In some embodiments, a system 100, 300, 400 as described herein include optical components which are selectively configurable by a user to vary the type of polarization of test light beam 107 (e.g. to select whether the light of test light beam 107 is not polarized, linearly polarized circularly polarized and/or a polarization direction).

In some embodiments, when focused for coupling into on an optical port of a DUT, test light beam 107 has a Gaussian beam profile. A width of test light beam 107 at the optical port may be matched to an acceptance angle, numerical aperture and/or entrance aperture of the optical port.

In some embodiments optics 116 are adjustable to vary an angle at which test light beam 107 is incident on DUT 104. This adjustability may be used, for example, where an optical port of DUT 104 comprises a grating coupler. The angle of incidence of the test light beam on the grating coupler may be set to an angle that corresponds to the most efficient coupling of light from the test light beam into the grating coupler. This angle depends on the construction of the grating coupler and the wavelength of light in the test light beam 107 as is understood by those of skill in the art. The grating coupler may be designed to couple light in a wavelength range that includes wavelengths of test light beam 107 into DUT 104.

Optics 116 may be configured in any suitable manner to set the angle of incidence of test light beam 107 on DUT 104. For example, by altering the angle relative to an optical axis of objective 108 at which test light beam 107 is incident on objective 108.

Those of skill in the art will understand that some mechanisms for adjusting the angle of incidence of test light beam on DUT 104 will also move the location at which test light beam 107 hits DUT 104. In some embodiments, system 100 includes controls that allow a user to move DUT 104 to keep test light beam 107 incident at a desired location on DUT 104 (e.g. a location corresponding to an optical port of the DUT 104) as the angle of incidence of test light beam 107 on DUT 104 is adjusted by a user. In some embodiments, system 100 includes control functionality that automatically moves DUT 104 to keep test light beam 107 incident at the desired location on DUT 104 as the angle of incidence of test light beam 107 on DUT 104 is adjusted by a user. For example, a controller may compute a displacement direction and magnitude resulting from a change of the angle of incidence of test light beam 107 relative to a surface plane of DUT 104 based on known geometry of system 100 and may control stage 102 to move DUT 104 in the direction by the magnitude of the displacement such that the test light beam continues to be incident at the same location relative to DUT 104.

In some embodiments, stage 102 comprises a tilt function and changes to the angle of incidence of test light beam 107 on DUT 104 may be achieved in whole or in part by operating the stage 102 to tilt DUT 104.

In some embodiments, optics 116 are adjustable to select one or more locations on DUT 104 from which response light 109 is collected. This functionality may be used, for example to collect response light 109 from an optical port of DUT 104 and to deliver the collected response light 109 to detector(s) 118 for detection and subsequent analysis.

One or more beams containing collected response light 109 are directed by objective lens 108 and optics 116 to detectors 118. Detectors 118 are operable to measure intensity and/or spectral information for each of the one or more beams of collected response light 109. In some embodiments, one or more of detector(s) 118 are a photon detector (e.g. an avalanche photodiode (APD) or photomultiplier tube (PMT)). In some embodiments, detectors 118 measure amplitude or intensity of response light 109 at times when the wavelength of test light beam 107 has different values to provide a set of measurements which characterizes a response spectrum (intensity as a function of wavelength) for a DUT. In some embodiments, test light beam 107 may include plural wavelengths simultaneously (e.g. test light source may comprise plural laser light sources and system 100 may include optical filters which direct the different wavelengths to different detectors 118 for simultaneous detection).

Output signals 111 from detector(s) 118 are acquired by a data acquisition unit 120. Data acquisition unit 120 may, for example, condition, digitize and time stamp output signals 111 from detector(s) 118. Controller 122 may then process acquired data 113 to yield information 117 that characterizes the performance of a DUT 104. For example, controller 122 may process acquired data 113 to provide information 117 such as:
information regarding attenuation of light that passes through one or more components of a DUT 104 (e.g. based on a comparison of the intensity of test light beam 107 and transmitted response light 109T);
information that characterizes a resonance of one or more components of a DUT 104 (e.g. resonant wavelength and Q factor) (e.g. based on a comparison of intensity and wavelength of test light beam 107 to an intensity of transmitted response light 109T or reflected response light 109R.
information that characterizes transmission of light through a portion of a DUT at a single wavelength and/or as a function of wavelength.
information that characterizes whether one or more optical paths in a DUT are open or blocked.
information that compares optical properties of different optical paths in a DUT.
information that compares optical properties of different components of a DUT.
etc.

Controller 122 may provide acquired data 113 and/or information 117 to an analysis unit 126 for storage and/or further analysis. The analysis unit 126 may, for example, determine a resonant wavelength and/or a quality factor for one or more optical structures of the DUT.

Controller 122 and/or analysis unit 126 may be configured to adjust acquired data 113 using calibration data which is accessible to controller 122 and/or analysis unit 126. The calibration data may, for example take into account characteristics of system 100 such as the sensitivity of detectors 118 as a function of wavelength, the actual wavelength of light emitted by test light source 114 as a function of an applied wavelength control signal, etc. The calibration data may, for example be generated by measuring the intensity of test light beam 107 as a function of wavelength with a calibrated reference light detector and using or generating calibration tables for detectors 118. The calibration data may define a calibration function of wavelength. One calibration function may correspond to plural detectors 118 or different calibration functions may correspond to different detectors 118. Output values of a detector 118 may be multiplied by a corresponding value for the corresponding calibration function to yield an output spectrum in which inaccuracies due to performance changes in detectors 118 as a function of wavelength and/or output intensity of test light source 114 as a function of wavelength and/or transmission of light through optical paths of the system as a function of wavelength are reduced or eliminated.

Controller 122 is configurable to control acquisition of data (e.g. by controlling test light source 114 to perform a wavelength sweep and coordinating acquisition of data regarding response light 109R and/or 109T that corresponds to different wavelengths of test light beam 107).

In some embodiments, controller 122 is configured or configurable to control configurations of optics 116 and/or stage 102 and/or data acquisition unit 120 (e.g. by control signals 115) for performing certain tests on DUTs 104 of different types and/or performing or coordinating optional automated functionality of system 100.

Controller 122 is not limited to being a single device or to being located at a single location. A controller 122 may, for example, be implemented using: specifically designed hardware, configurable hardware, one or more programmable data processors configured by the provision of software (which may optionally comprise “firmware”) capable of executing on the data processors, one or more special purpose computers or data processors that is specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, industrial process controllers, programmable logic controllers (“PLCs”), general purpose computers, server computers, cloud computers, mainframe computers, computer workstations, and the like. For example, one or more data processors in a controller for a system as described herein may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

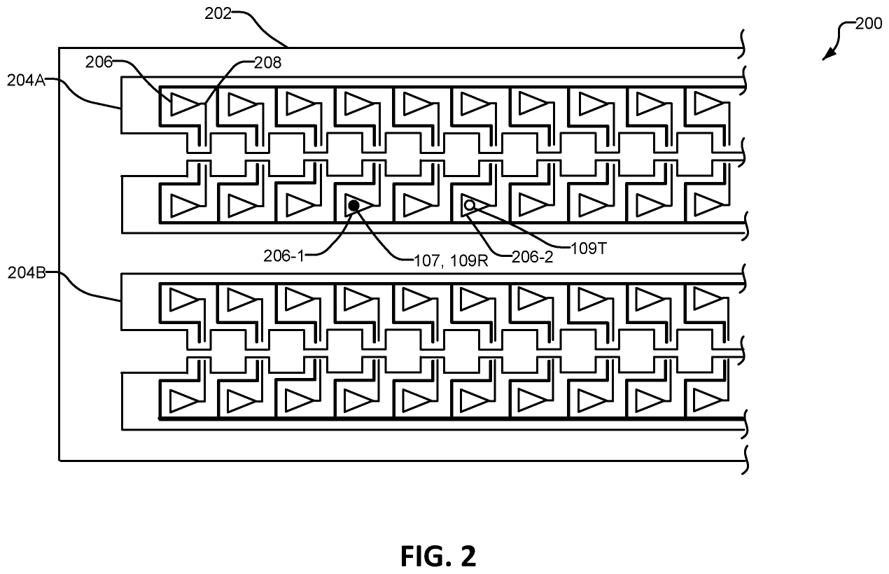

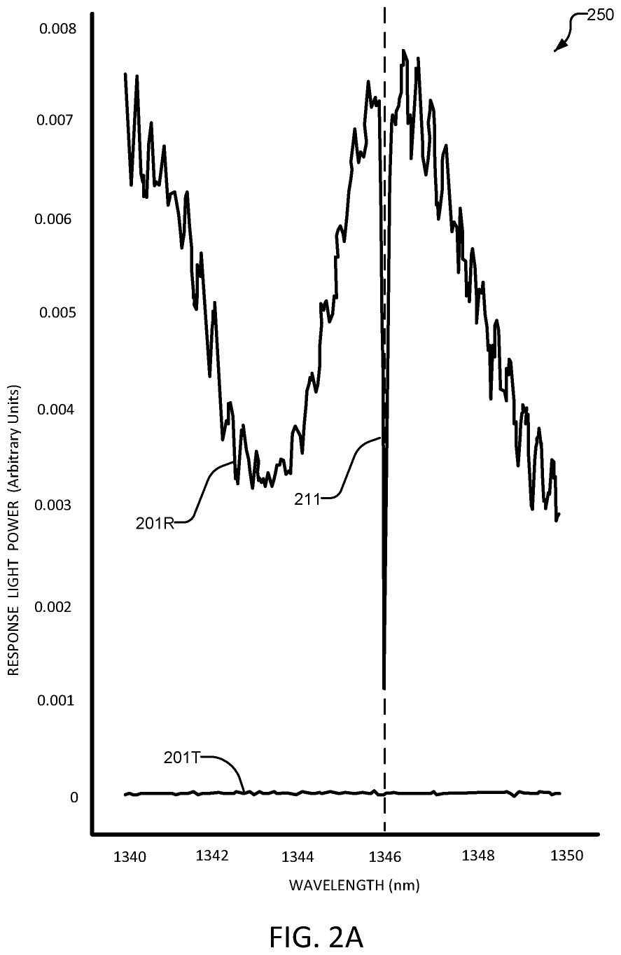

FIG. 2 is a schematic partial top view of an example device 200 of a type which might be tested using a system as disclosed herein (for example, system 100). Device 200 comprises a substrate 202. Integrated photonic circuits 204A and 204B are fabricated on substrate 202. Integrated photonic circuits 204A and 204B each comprises a plurality of optical ports 206 (shown as being triangular in shape in FIG. 2), waveguides 208 and other optical components (not shown) selected to provide desired functionality for integrated photonic circuits 204A and 204B.

One or more of optical ports 206 may comprise a grating coupler (not illustrated). Different grating couplers may require different beam angles for most efficiently coupling of test light beam 107 into the optical port 206 and/or most efficiently coupling response light 109 out of the optical port 206.

Light may enter an optical port 206 and interact with optical components of photonic circuit 204A or 204B to yield reflected and/or transmitted response light 109. In the case where light from test light beam 107 interacts with one or more components that are resonant at a particular wavelength, the amplitude of the reflected and/or transmitted response light 109 can depend on the difference between the resonant wavelength of the optical components and the wavelength of light in test light beam 107.

For example, a system 100 may be configured to deliver test light beam 107 (shown as a dark circle in FIG. 2) to an optical port 206-1. As a result of interactions with components of integrated photonic circuit 204A, reflected response light 109R is emitted from optical port 206-1. Transmitted response light 109T may be emitted at one or more other optical ports 206, for example at optical port 206-2. Optics 116 may be configured to collect one or more of: reflected response light 109R and transmitted response light 109T.

FIG. 2A is a plot 250 which includes a curve 201R which indicates intensity of reflected response light 109R (in arbitrary units) as a function of the wavelength of light in test light beam 107 as the wavelength of light in test light beam 107 is swept over the range of 1340 nm to 1350 nm. In this example a resonance at a wavelength of approximately 1346 nm is indicated by a line 211. The width of line 211 indicates a quality factor (“Q”) of the resonance.

FIG. 2A includes a curve 201T which indicates intensity of collected transmitted response light 109T. However, in this example, transmitted response light 109T is not being collected (and consequently curve 201T has a value of “0”).

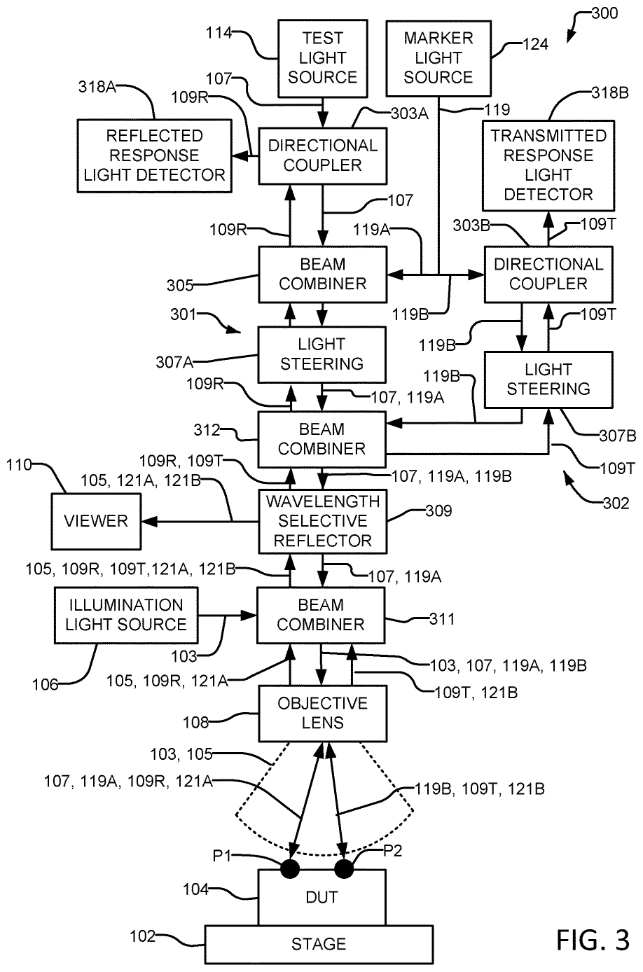

FIG. 3 schematically illustrates an optical arrangement for a testing system 300 according to one example embodiment. Certain components of system 300 are functionally equivalent to components shown in FIG. 1 in relation to system 100. Certain components of system 300 that are functionally equivalent to components of system 100 and system 300 are labelled with the same reference numerals in FIGS. 1 and 3.

The optical arrangement of system 300 facilitates the collection of reflected response light 109R by a reflected response light detector 318A and the collection of transmitted response light 109T by a transmitted response light detector 318B.

System 300 comprises various optical paths that carry light beams from light sources to a DUT 104 and/or carry light collected from DUT 104 to detectors of system 300. Any of these optical paths may include portions where light propagates through a light guide such as an optical fiber and/or portions where light propagates through free space (e.g. guided by optical components such as lenses, mirrors, prisms etc. Advantageously, in the portions of the optical paths that extend between a DUT 104 and objective lens 108, light may propagate through free space.

System 300 comprises a marker light source 124 configured to emit a first marker beam 119A and a second marker beam 119B. In some embodiments system 300 comprises a beam splitter (not shown in FIG. 3) to split a marker beam 119 into first marker beam 119A and second marker beam 119B. In some embodiments marker light source 124 comprises separate emitters corresponding to marker beams 119A and 119B. Marker beam 119A is directed onto DUT 104 through a first optical path 301 and second marker beam 119B is directed onto DUT 104 through a second optical path 302. Light scattered at DUT 104 from first marker beam 119A is collected as reflected first marker beam 121A upon being incident on DUT 104. Light scattered at DUT 104 from second marker beam 119B is collected as reflected second marker beam 121B.

Reflected first marker beam 121A and reflected second marker beam 121B are directed to viewer 110 together with reflected illumination light 105 by a wavelength selective reflector 309 after passing through objective lens 108 and beam combiner 311. Collection of reflected first and second marker beams 121A and 121B at viewer 110 allows a user and/or a controller to observe the respective spots at which first and second marker beams 119A and 119B are incident on DUT 104.

The optical arrangement of system 300 maintains the locations at which test light beam 107 and first marker light beam 119A are incident on DUT 104 coincident with one another and also with the locations at which reflected response light 109R is collected by carrying all of these beams on first optical path 301.

System 300 comprises a directional coupler 303A configured to direct test light beam 107 from test light source 114 into optical path 301 and to direct reflected response light 109R to detector 318A. Test beam light 107 is directed by directional coupler 303A to a beam combiner 305 (e.g. a wavelength division multiplexer (WDM)) where test light beam 107 is combined with first marker beam 119A. Then the combined beam is steered by light steering unit 307A onto DUT 104 through beam combiner 312, wavelength selective reflector 309, beam combiner 311 and objective lens 108 along first optical path 301. After being incident upon DUT 104, reflected response light 109R and reflected first marker beam 121A are collected and sent back onto first optical path 301. Reflected first marker beam 121A is directed to viewer 110 by wavelength selective reflector 309. Reflected response light 109R passes through wavelength selective reflector 309 and is directed by directional coupler 303A, which may comprise a circulator, to reflected response light detector 318A after passing through light steering unit 307A and beam combiner 305.

The optical arrangement of system 300 may facilitate the collection of transmitted response light 109T at a location that coincides with a location at which second marker beam 119B is incident on DUT 104. For example, system 300 may be configured to ensure alignment between the location on DUT 104 at which transmitted response light 109T is collected and second marker beam 119B is incident by directing second marker beam 119B onto the same optical path 302 that is used to collect transmitted response light 109T.

Test light 107 and reflected response light may respectively be incident and collected at a first optical port of a DUT 104. Transmitted response light 109T may be collected at a second optical port of DUT 104. For example, in FIG. 3, P1 denotes a first optical port and P2 denotes a second optical port. Optical port P2 is optically related to optical port P1 such that light from test light beam 107 is carried from P1 to P2 by optical components of DUT 104 such that transmitted response light 109T is emitted from optical port P2 of DUT 104.

In operation, system 300 may be configured to set the locations on DUT 104 at which test light beam 107 will be incident and response light 109T and/or 109R will be collected. This may be performed while test light source 114 is off. A user or controller 122 (not shown in FIG. 3) may control light steering unit 307A and/or stage 102 to deliver first marker beam 119A to a desired location (e.g. optical port P1) on DUT 104 at the desired incident angle by observing reflected first marker beam 121A through viewer 110. After first marker beam 119A is aligned to be incident on optical port P1 at the desired incident angle, the user or controller 122 may control light steering unit 307B to deliver second marker beam 119B to a desired location (e.g. optical port P2) on DUT 104 by observing reflected second marker beam 121B through viewer 110.

After first marker beam 119A (and second marker beam 119B if transmitted response light 109T is to be collected) have the desired alignment a test may be performed by causing test light beam to be incident on DUT 104 and collecting one or both of response light 109R, 109T. For performing the test, marker light is not required and marker light source 124 may be turned off. In this example, for the test, test light beam 107 is incident upon DUT 104 at optical port P1 at the desired angle of incidence and reflected response light 109R will be collected and measured at reflected response light detector 318A because test light beam 107 and reflected response light 109R are set up to traverse the same optical path 301 as first marker beam 119A. Transmitted response light 109T will be collected and measured at transmitted response light detector 318B because transmitted response light 109T is set up to traverse the same optical path 302 as second marker beam 119B. Transmitted response light 109T is delivered to transmitted response light detector 318B by way of beam combiner 312, light steering unit 307B, and directional coupler 303B.

System 300 may be varied in many ways without departing from the principles of operation described above. For example, any or all of beam combiners 305, 311, 312, directional couplers 303A, 303B, and wavelength selective reflector 309 may be implemented by suitable beam combiners that are operable to combine beams of different wavelengths.

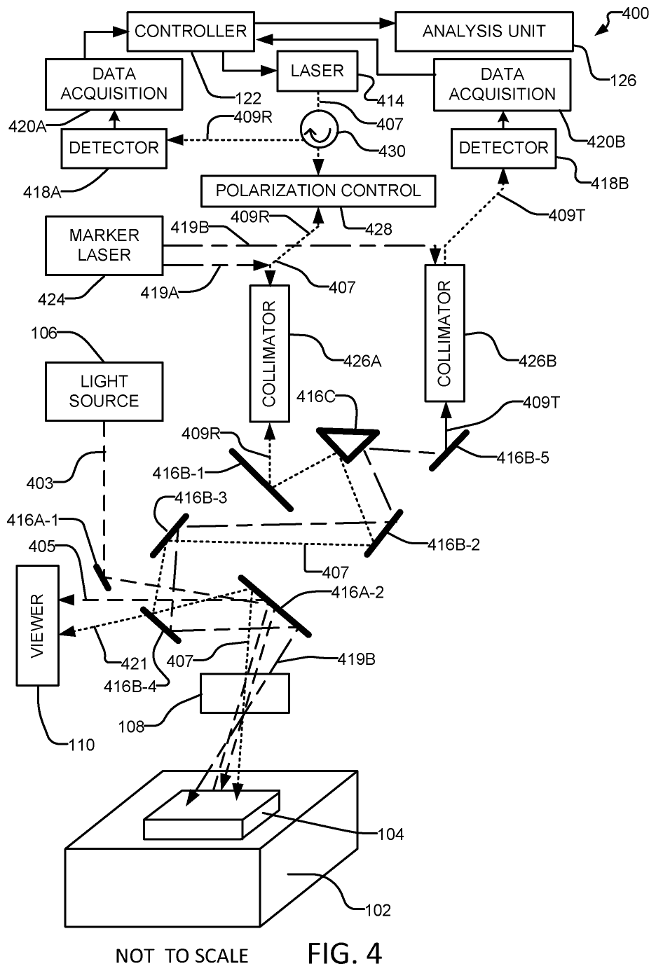

FIG. 4 schematically illustrates an optical arrangement for a testing system 400 according to another example embodiment. Certain components of system 400 are functionally equivalent to components shown in FIG. 1 in relation to system 100. Certain components of system 400 that are functionally equivalent to components of system 100 and system 400 are labelled with the same reference numerals in FIGS. 4 and 1.

System 400 comprises a stage 102 adapted to carry a DUT 104 for testing by system 400.

A light source 106 is operable to emit illumination light 403 which is directed by optical elements 416A-1 and 416A-2 (generally and collectively elements 416A) onto DUT 104 through objective lens 108. Optical elements 416A may, for example, comprise mirrors.

A portion of illumination light 403 is scattered at DUT 104 and is returned to viewer 110 as scattered illumination light 405. Scattered illumination light 405 is collected by objective lens 108 and directed by optical elements 416A and 416B to viewer 110 which provides a magnified image of DUT 104.

Light source 106, objective lens 108 and viewer 110 together allow a user to directly observe DUT 104 when the user is using system 400 to conduct testing of DUT 104.

System 400 comprises a laser 414 configured to emit test light beam 407. In some embodiments laser 414 comprises a tunable laser. Test light beam 407 is delivered through a circulator 430 to a polarization control 428.

Polarization control 428 allows the polarization of test light beam 407 to be adjusted for coupling into DUT 104. After exiting polarization control 428, test light beam 407 is directed to collimator 426A. Collimator 426A is configured to collimate test light beam 407. In some embodiments, collimator 426A is configured to size (e.g. expand) test light beam 407 to a size sufficient to substantially fill or somewhat overfill an aperture of objective lens 108. In the illustrated embodiment, test light beam 407 is directed to the aperture of objective lens 108 by elements 416B-1 to 416B-4 and 416A-2 and 416C.

In some embodiments, optical element 416C comprises a prism mirror operating as a knife-edge mirror with reflective coating applied on the surface of the two legs of the triangular prism such that test light beam 407 and reflected response light 409R reflects off the first coated surface and transmitted response light reflects off the second coated surface.

Objective lens 108 focuses test light beam 407 to provide a focused spot on DUT 104. The location of the focused spot may be adjusted, for example by altering the angle at which the collimated test light beam enters objective lens 108. This may be achieved by example by tilting one or more of elements 416B. For example, element 416B-3 may be tilted about an axis to move the focused spot in one direction (e.g. x) and element 416B-4 may be tilted about an axis to move the focused spot in another direction (e.g. y) or element 416B-4 may be tilted about first and second axes to position the focused spot in two dimensions. The focused spot may, for example, be positioned to coincide with a first optical port of DUT 104. In some embodiments the focused spot is positionable with a repeatability of about 1 micron or less.

The light of test beam 407 interacts with DUT 104 to produce reflected response light 409R and/or transmitted response light 409T. Reflected response light 409R is emitted at the location of the focused spot of test light beam 407. As a result, reflected response light 409R follows the path of test light beam 407 in reverse up to circulator 430.

Reflected response light 409R enters circulator 430 which is configured to direct reflected response light 409R to detector 418A. Detector 418A generates an output signal that encodes information regarding one or more characteristics (e.g. intensity, power) of reflected response light 409R. The output signal from detector 418A is delivered to data acquisition unit 420A (e.g. a channel of data acquisition unit 120 of FIG. 1). The acquired data regarding reflected response light 409R may then be provided to controller 122 and/or an analysis unit 126 for processing (e.g. as described elsewhere herein).

Transmitted response light 409T is emitted at a location on DUT 104 that is different from the location at which test light beam 407 makes a focused spot. System 400 provides an optical path by way of which transmitted response light 409T is delivered to detector 418B. For example, in the embodiment illustrated in FIG. 3, transmitted response light 409T that is emitted from a selected location on DUT 104 (e.g. a location of a second optical port of DUT 104) is collected by objective lens 108, and then guided by elements 416A-2, 416B-4, 416B-3, 416B-2 and 416C to element 416B-5 which directs transmitted response light 409T into collimator 426B.

The specific location on DUT 104 at which transmitted response light 409T is collected may be set by tilting one of the elements (e.g. element 416B-5) that defines the optical path along which transmitted response light 409T is carried to detector 418B.

As mentioned above certain optical elements (e.g. one or more of elements 416B-1 to 416B-5) may be adjustable to vary a location at which test light beam 407 is focused onto DUT 104 and/or to vary a location from which transmitted response light 409T is collected. These adjustments may also vary the angle at which test light beam 407 is incident on DUT 104. System 400 may include any suitable mechanisms for varying the angle at which test light beam 407 is incident on objective lens 108 (and therefore the location and angle of incidence at which test light beam 407 is incident on DUT 104. For example, one or more of elements 416B-1 to 416B-5 (and/or an additional optical element that is included for steering test light beam 407) may be actuated to tilt by actuators such as piezoelectric actuators. Controller 122 may control such actuators.

System 400 may further comprise a marker or alignment laser 424 that emits light of a wavelength which causes a spot visible at viewer 110 when the light is incident on DUT 104. For example, marker laser 424 may emit light of a wavelength that is in the visible spectrum (e.g. red light or green light) and/or of a wavelength to which viewer 110 is sensitive and/or a wavelength that causes emission of secondary light (e.g. fluorescence) to which viewer 110 is sensitive. Light from marker laser 424 is injected into the optical path that carries test light beam 407 to objective lens 108 and/or into the optical path that carries transmitted response light 409T between objective lens 108 and detector 418B. The points of injection may be chosen so that any steering elements that steer the location at which test light beam is incident on DUT 104 and any steering elements that steer the location from which transmitted response light 409T is collected at DUT 104 are between the points of injection and DUT 104. In this manner, light from marker laser 424 provides spots on DUT 104 that correspond to the location at which test light beam 407 is or will be incident on DUT 104 and/or the location from which transmitted response light 409T is being or will be collected. These spots may be viewed on viewer 110.

In some embodiments, the light emitted by marker laser 424 is blocked from reaching sensors 418A, 418B (e.g. by suitable filters) and/or sensors 418A, 418B are not sensitive to the light from marker laser 424 and/or marker laser 424 is turned off when system 400 is making measurements.

In the example system 400, a first beam of light 419A from marker laser 424 is combined with test light beam 407 at a location between collimator 426A and polarization control 428. For example, a suitable multiplexer or wavelength combiner (e.g. a dichroic mirror which reflects marker laser beam 419A and passes test light beam 407) is used to merge marker laser beam into the optical path that delivers test light beam 407 to DUT 104.

In the illustrated example system 400, a second marker laser beam 419B is merged into the optical path that carries transmitted response light 409T. The point of injection is between collimator 426B and detector 418B. A suitable multiplexer or wavelength combiner may be used to merge marker laser beam 419B into the optical path in a direction toward DUT 104.

In operation, a user of a testing system as disclosed herein may first observe a surface of DUT 104 on viewer 110. The user may, for example locate one or more optical ports on DUT 104 and may observe whether or not DUT 104 has a desired orientation. The user may optionally adjust the orientation of DUT 104 by moving DUT 104 using stage 102. With marker laser 424 operating, the user may adjust stage 102 and/or a light steering mechanism to select a location on DUT 104 to which test light beam 407 will be directed and optionally to select a second location on DUT 104 at which transmitted response light 409T will be collected by observing reflected marker beam 421. At the same time the user may cause test light beam 407 to reach the selected location on DUT 104 at a desired angle of incidence. In some embodiments, a display of viewer 110 is marked with a reticle or the like that includes lines of constant angle of incidence. A desired angle of incidence for test light beam 407 may be established by placing the target location for test light beam 407 on one of the lines that correspond to the desired angle of incidence and operating a light steering mechanism to direct the test light beam 407 to the desired location. The user may then operate the system to collect data from DUT 104 by applying the test light beam 407 beam to the DUT 104 and collecting one or both of reflected and transmitted response light 409R, 409T. The wavelength of the test light beam 407 may be varied as a series of measurements are taken. This process may be repeated to test different aspects of the same DUT 104 by performing different test protocols which may interface with DUT 104 at different optical ports.

In some DUT 104, response light 109R and/or 109T include light that has been reflected at plural locations within DUT 104. The light reflected at different locations within DUT 104 may interfere. The interference may vary with wavelength of test light beam 107. This interferometric information may provide additional insight into the characteristics of DUT 104.

By applying the testing systems disclosed herein, users can directly observe the influence of different fabrication parameters on end photonic functions of a DUT. Advantageously, tests may be performed on a DUT without making contact with the DUT (except for supporting the DUT on stage 102) and without damage to the DUT and without exposing the DUT to potentially damaging environments. Ultra-accurate results may be obtained for resonant frequencies and/or quality factors of resonant optical components where the test light source is stable, has a narrow bandwidth and an accurately variable wavelength and the response light 109R, 109T, 409R, 409T is detected by high precision detectors 118, 418A, 418B for example. Conventional microscopy and characterization tools may still be used concurrently to provide complementary information and insight.

Systems as described herein may even be used between fabrication steps. For example, one can monitor photonic functionality at one or more intermediate stages of a fabrication process in a precise and non-destructive manner. Results of these tests may be fed forward by tuning parameters of subsequent process steps in response to the test results. This provides the opportunity to correct for uncertainties throughout a process for fabricating photonic devices. For example, the systems disclosed herein can provide information about the resonant wavelength of micro cavities. Subsequent fabrication steps may tune the resonant wavelengths to achieve desired target resonant wavelengths using the obtained information.

At the end of the fabrication process, a system as described herein may be used for quality control.

Systems as described herein may be varied in many ways without departing from the present invention. For example:
There are numerous ways to provide an optical path from a test light source onto a DUT that facilitate steering a test light beam from the test light source to be incident on the DUT at a desired location. The optical path may include free space portions in which the test light beam is guided by optical elements such as mirrors, lenses, prisms, etc. and/or portions in which the test light beam is carried by a light guide such as an optical fiber. A wide range of steering arrangements may be used to steer the test light beam. For example, a test light beam may be steered by a scanner such as a galvanometer based scanner, an optoacoustic scanner, a tilting mirror or the like. Similarly, there are numerous techniques for providing an optical path that collects transmitted response light 109T, 409T from a desired location on a DUT and carries that transmitted response light to a detector.
It is not mandatory that the test light be constantly illuminating a point on the DUT during a test. In some embodiment the test light beam is pulsed on and off and/or moved to scan over an optical port to be used for the test. In such cases, the fact that the test light beam is not being continuously applied to an optical port during the test can be used for noise reduction (e.g. detection of response light 109, 409 using a lock-in amplifier).
Marker light from a marker light source may be delivered to a DUT by the same optical path and steering used to deliver a test light beam to the DUT and/or the same optical path used to collect transmitted response light from the DUT and/or a separate path that includes a light steering system that is controlled to direct marker light to locations that coincide with a current target location for a test light beam and a current target location for collecting transmitted response light.
The disclosed embodiments provide one test light beam. Other embodiments may include two or more test light beams that are controllable to be incident at different target locations on a DUT. A detector for reflected response light 109R, 409R may be provided for each of the test beams. One or more optical paths and detectors for collecting and detecting transmitted response light 109T, 409T from one or more corresponding location on the DUT may be provided for each of the test beams. This may allow testing different portions of a DUT simultaneously.
An enclosure may be provided to exclude ambient light and to enhance safety while tests are being performed.
A system as described herein may be configured to scan test light beam over a DUT 104 and to process output signals corresponding to points in a scanning path to yield a scanned image of DUT 104. A wavelength of a test light source may be controlled to acquire images f the DUT 104 at plural different wavelengths. A polarization of test light beam 107 may be adjusted to image DUT 104 with one or more polarizations of light.

Systems as described herein may include a range of optional features that may enhance the ease and speed and/or usability of the systems. Some example of such optional features are:
Locations of optical ports on a DUT may be known in advance. The DUT may be oriented so that it is registered with a coordinate system in which the optical ports can be located. The orientation may be performed manually by a user or automatically (e.g. using feedback from viewer 110 to control stage 102 to orient the DUT so that certain reference features of the DUT are at known locations. As another example, a machine vision system (e.g. provided by controller 122) may process images of the DUT acquired from viewer 110 to identify and determine coordinates for optical ports and/or other reference features of the DUT. In some embodiments, controller 122 uses known coordinates of the optical ports and/or reference features to control stage 102 and light steering mechanisms to direct one or more test light beam to corresponding optical ports of the DUT. In some embodiments, controller 122 is also configured to controls one or more light steering mechanism respectively associated with a corresponding optical path for transmitted response light to collect transmitted response light at a corresponding location on the DUT.
Controller 122 may be configured to perform a series of tests in a sequence. The series of tests may use the same or different optical ports of the DUT.
A system as described herein may be configured to collect and detect transmitter response light simultaneously at two or more different locations on a DUT.

Where a component (e.g. a software module, controller, processor, assembly, device, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A system for testing a device under test (DUT) that is moveable relative to an objective lens, the system comprising:
a first optical system, the first optical system comprising:
a viewer configured to observe the DUT when illuminated by an illumination light, emitted by a light source, through the objective lens; and,
a second optical system, the second optical system comprising:
optical elements configured to deliver a test light beam, emitted from a test light source, to be incident onto the DUT through the objective lens wherein the test light beam is transmitted and/or reflected as a transmitted and/or reflected response light upon being incident on the DUT;
one or more detectors configured to detect the transmitted and/or reflected response light from the DUT.

2. The system of claim 1 wherein the DUT is supported by a stage operable to move the DUT relative to the objective lens, wherein the stage is operable to position the DUT in two or more degrees of freedom by translation and/or rotation.

3. (canceled)

4. The system of claim 2 wherein the stage is operable to position the DUT in 6 degrees of freedom.

5. The system according to claim 2 comprising a controller configurable to control the optical elements and/or the stage to vary an angle of incidence of the test light beam on the DUT, wherein the angle of incidence of the test light beam on the DUT is selected to couple light from the test beam into an optical element internal to the DUT.

6. (canceled)

7. The system according to claim 1, comprising a marker light source configurable to emit first and second marker beams wherein the first marker beam is aligned with the reflected response light along a first optical path and the second marker beam is aligned with the transmitted response light along a second optical path.

8. The system of claim 7 wherein the first and second optical paths are configurable to collect response light from first and second optical ports of a plurality of optical ports that are spaced apart from one another on the DUT.

9. (canceled)

10. The system of claim 7 wherein the controller is configurable to deliver the test light beam to a desired location on the DUT by adjusting the optical elements so that a spot of light made by the first marker beam on the DUT is positioned at the desired location, wherein the desired location is at any one of the plurality of optical ports on the DUT.

11. (canceled)

12. The system of claim 10 wherein the controller is configurable to control the optical elements to deliver the second marker beam to a location on the DUT from which the transmitted response light is expected to be emitted, wherein the location on the DUT from which the transmitted response light is expected to be emitted is at one of the plurality of optical ports on the DUT.

13. (canceled)

14. The system of claim 12 wherein one of the plurality of optical ports from which the transmitted response light is emitted is different from the one of the plurality of optical ports to which the test light beam is incident.

15. The system of claim 14 wherein the optical elements comprise a wavelength selective reflector in the first optical path configured to direct reflected illumination light and reflected first and second marker beams to the viewer and allow reflected response light to proceed to respective detectors of the one or more detector.

16. The system of claim 15 wherein the optical elements comprises a first light steering unit in the first optical path configured to steer the test light beam and/or the first marker beam to the desired location on the DUT through the objective lens.

17. The system of claim 16 wherein the detectors comprises a reflected response light detector and the optical elements comprises a first directional coupler in the first optical path configured to direct the reflected response light to the reflected response light detector.

18. The system of claim 17 wherein the first directional coupler comprises a light circulator and a polarization control unit wherein the polarization control unit is configured to apply polarization to the reflected response light such that the light circulator directs the reflected response light to the reflected response light detector.

19. The system of claim 17 wherein the optical elements comprises a first beam combiner in the first optical path configured to combine the test light beam and the first marker beam before the test light beam and/or the first marker beam is steered by the first light steering unit.

20. The system of claim 18 wherein the optical elements comprise a second light steering unit in the second optical path configured to steer the second marker beam to the location on the DUT from which the transmitted response light is expected to be emitted.

21. (canceled)

22. The system of claim 20, wherein the second optical system comprises the test light source, and wherein the test light source comprises a tunable laser and the system is configured to sweep a wavelength of light emitted by the tunable laser over a wavelength range while detecting the transmitted and/or reflected response light from the DUT.

23.-24. (canceled)

25. The system of claim 22, wherein the marker light source comprises a laser and the laser is configured to emit the first and second marker beams with a wavelength outside of the wavelength range of the test light beam.

26. The system of claim 25, wherein the first and second marker beams have a wavelength in the visible light spectrum.

27. The system of claim 22, wherein the wavelength range of the test light beam is outside the visible light spectrum.

28.-29. (canceled)

30. The system of claim 1, comprising a data acquisition unit configured to receive output signals from the one or more detectors, and an analysis unit configured to store and/or analyze data from the data acquisition unit, wherein the analysis unit is configured to determine a resonant wavelength and/or a quality factor for one or more optical structures of the DUT.

31.-37. (canceled)
